(19) United States
(12) Patent Application Publication
(10) Pub. No.: US 2007/0124999 A1
(43) Pub. Date: Jun. 7, 2007

(54) DOOR WRAP

(76) Inventors: Michael P. Blake, Macomb Township, MI (US); Raymond A. Blake, Armada, MI (US)

Correspondence Address: CARGILL & ASSOCIATES, P.L.L.C., 56 MACOMB PLACE, MT. CLEMENS, MI, 48043, US

(21) Appl. No.: 11/537,088

(22) Filed: Sep. 29, 2006

Related U.S. Application Data
(60) Provisional application No. 60/721,651, filed on Sep. 29, 2005.

(51) Int. Cl. E05D 15/22

(52) U.S. Cl. 49/202

(57) ABSTRACT

A door wrap including two piece door surface cover connected by a middle jointing section for attachment to a door to protect both sides or top edge of the door on which it is mounted. The door wrap not only protects the door, but also allows the door to be fully functional, such as to be opened, closed or locked. The two-piece door surface covers of the door wrap may be constructed from a piece or pieces of cardboard material while the middle joining section may be made of plastic material. The door wrap may be custom made for uniquely mounted or sized doors, or assembled in standard sizes to fit most doors.

### CROSS REFERENCES TO RELATED APPLICATIONS

This application claims the benefit under 35 U.S.C. 119(e) of U.S. Provisional Application No. 60/721,651 filed on Sep. 29, 2005.

### BACKGROUND OF THE INVENTION

1. Field of the Invention

The present invention generally relates to door wraps and more particularly the invention relates to door wraps used in construction sites to protect the doors and advertise a builders' name during construction.

2. Description of the Prior Art

The doors of residences, commercial buildings, offices, etc. are subjected to accidental abuse, damage, marking or mistreatment during construction, moving, painting, remodeling, or the like. Due to the high cost of labor to repair or replace, as well as the inconvenience of removing, repairing and/or replacing doors mounted in a door frame, it is necessary to protect the vulnerable surfaces of doors from accidental damage or harm. The damage may be caused by dripping paints, sprays, adhesives, and plasters; or by contact of moving objects, such as furniture, tools, wall portions, or the like.

Conventional means for covering and protecting doors against damage or harm are known in the art. Most conventional door protectors are generally of the disposable type, and they are not designed to fit all doors, nor are they designed to fit most edges or both sides of a single door or a set of double doors. Furthermore, they do not allow the doors so covered thereby to function properly so as to be opened, closed or locked in a usual manner. Therefore, after many attempts to solve the problems of ease in using and manufacturing a relatively low-cost and reusable protective door wrap there still exists a need in the door protecting art for improvements.

It would be a great advantage to the construction industry if there was provided a relatively simple, easy to install and remove, low-cost protective door wrap that may be made to cover substantially two sides of a door, while at the same time allowing the door to function normally and to be opened and closed for everyday use.

### SUMMARY OF THE INVENTION

In accordance with the above-noted advantages and desires of the industry, the present invention provides a protective door wrap. The present invention of the door wrap overcomes the aforementioned problems with the conventional door protectors and provides advantages. The door wrap of the present invention speeds up construction, moving, painting, and remodeling processes and alleviates damage to the door. In addition to protecting the door, while covering the door, the door wrap may also be utilized for marketing purposes, such as advertising a builders' name.

One specific preferred embodiment of the door wrap has certain features including a first and a second surface covers and a connector connecting the first and second surface covers together to be adapted to cover and protect the door. Each of the first and second surface covers has a substantially rectangular shaped portion dimensioned for covering substantially all of the front or back surface of the door. The connector may be a piece of material that connects the first and second surface covers into one single piece that is adapted to cover the top edge or side edges of the door. The connector may be a conventional fastener such as adhesive stripes, Velcro® strips, tapes, or rubber bands.

Another preferred embodiment of the door wrap has other features including a first and second surface covers with a middle joining section attached to one end of the first and second surface covers to connect the first and second surface covers. In this embodiment, the first and second surface covers are secured together over and around the door for covering substantially both the front and back surface of the door. The middle joining section may be adapted to engage with the top edge portion of the door for suspending the door wrap over the door while positioning the door wrap laterally relative to the door.

A third preferred embodiment of the door wrap includes first and second cardboard sections adapted to be secured together over the door for covering substantially both the front and back surface of the door joined together by a plastic joining section attached to one end of the first and second cardboard sections to connect the first and second cardboard sections. The plastic joining section is adapted to engage with the top edge portion of the door for the purpose of suspending the door wrap on the door and positioning it laterally relative to the door.

Although the invention will be described by way of examples hereinbelow for specific embodiments having certain features, it must also be realized that minor modifications that do not require undo experimentation on the part of the practitioner are covered within the scope and breadth of this invention. Additional advantages and other novel features of the present invention will be set forth in the description that follows and in particular will be apparent to those skilled in the art upon examination or may be learned within the practice of the invention. Therefore, the invention is capable of many other different embodiments and its details are capable of modifications of various aspects which will be obvious to those of ordinary skill in the art all without departing from the spirit of the present invention. Accordingly, the rest of the description will be regarded as illustrative rather than restrictive.

### BRIEF DESCRIPTION OF THE DRAWINGS

For a further understanding of the nature and advantages of the expected scope and various embodiments of the present invention, reference shall be made to the following detailed description, and when taken in conjunction with the accompanying drawings, in which like parts are given the same reference numerals, and wherein:

FIG. 1 is a perspective view of a first embodiment of a door wrap made in accordance with the present invention hung on a door without a doorknob;

FIG. 2 is a side cross-sectional view of the door wrap of FIG. 1;

FIG. 3 is a side perspective view of a protected door with a doorknob illustrating the relative placement of a preferred embodiment of the door wrap of FIG. 1;

FIG. 4 is a perspective view of a second embodiment of the door wrap made in accordance with the present invention having a cut-out portion to accommodate a doorknob;

FIG. 5 is a perspective view of a third embodiment of the door wrap made in accordance with the present invention; and

FIG. 6 is a perspective view of a fourth embodiment of the door wrap made in accordance with the present invention.

### DETAILED DESCRIPTION OF THE INVENTION

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide for an improved protective door wrap assembly shown in the drawings.

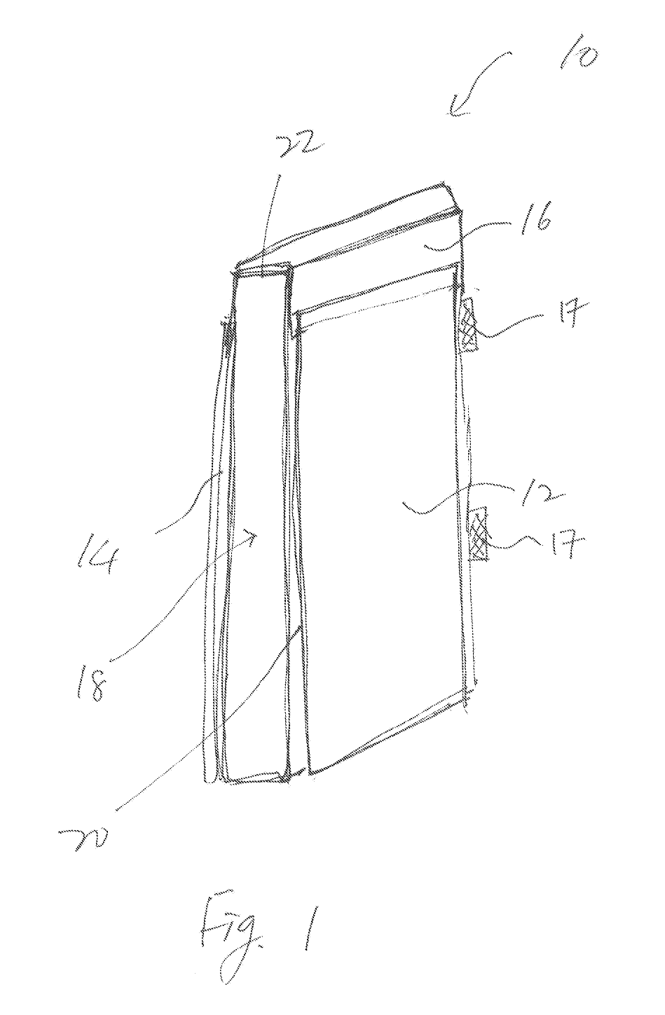

Referring now to the drawings in detail, FIG. 1 is a perspective view of a first embodiment of the present invention of a door wrap, generally indicated by the numeral 10. Door wrap 10 is draped over a door 18 hung in a frame by hinges 17. The door wrap 10 preferably includes a first door surface cover 12, a second door surface cover 14 and a middle joining section 16 attached to one end of the first door surface cover 12 and second door surface cover 14. Middle joining section 16 fastens and connects the top portions of first door surface cover 12 and second door surface cover 14. Door wrap 10 may be adapted to cover both a front surface 20 and a back surface (not shown) of the door 18 to reduce damage caused by dripping paints, sprays, adhesives, or plasters and contact with moving furniture or the like.

The first door surface cover 12 and second door surface cover 14 are adapted to be secured together over the door 18 for covering substantially both the front surface 20 and back surface (not shown) of the door 18. Generally, door surface covers 12 and 14 are sized to engage a substantial portion of the door 18. Each of the door surface covers 12 and 14 may be preferably in a substantially rectangular shape dimensioned to cover various sizes of doors. For various applications, the sizes and shapes of the first and second door surface covers 12 and 14 of the door wrap 10 may be specifically configured to work on every door. First and second door surface covers 12 and 14 may be custom made for uniquely mounted or sized doors, as well as standard size covers to fit most doors of a particular type. The door wrap of the present invention is easily adjusted for different sizes or shapes of doors because the first and second door surface covers may be resized or reshaped by ordinary tools such as knife, blades, scissors, and shears. The conventional doors on which the door wraps may apply include, but not be limited to, entry doors, cabinet doors, shelf doors and appliance doors. This adjustability factor becomes important at a job site because a worker may find it necessary to adjust the size of the door wrap after he arrives at a job site. He would not want to have to leave in order to cut the door wrap. Under these circumstances, it may be very advantageous to be able to use a utility knife to modify the size of the door wrap to make it fit.

Various materials may be used for the first and second door surface covers 12 and 14, including sturdy and preferably puncture-resistant or puncture-proof plastics, fabrics, foam, cardboard and combinations thereof The preferred plastic materials may be polypropylene or polyethylene. While the inventors herein envision the utilization of plastic materials, cardboard materials that have a high pulp content are especially preferred. Because cardboard is not only lightweight, durable and weight-bearing, but also 100% recyclable, using cardboard for door wraps is landfill compliant.

Among the various materials, cardboard that has an impact barrier on the outside and a cushioning layer on the inside is the most preferred for making the door wrap including two door surface covers of the present invention. Therefore, doors are protected against impact and also against rubbing of the door wraps on the doors that might, without a cushion, cause scratching.

Today's cardboard usually consists of outer flat sheets (“liners”) of puncture resistant paper, sandwiching a central “filling” of corrugated short fiber paper (“fluting medium”), which resists crushing under compression and gives cushioning protection to covered doors. The cardboard has high end-to-end strength along the corrugated flutes, so the door surface covers of the door wrap are normally designed with the flutes running horizontally for stacking strength. Cardboard made from short fiber hardwood pulp has good compression strength and is easily moldable with moisture and heat, but is weak in tension and tears easily. Cardboard made from softwoods, with their longer fibers, on the other hand, is strong in tension and resists puncturing and tearing better and is less plastic, so it tends to keep its shape. It also provides a better surface for printing. The door wrap of the present invention may preferably use cardboard made from softwoods.

The conventional liners and corrugated medium are glued together along the outsides of the peaks and valleys of each flute, normally using starch adhesives. The starch is usually derived from corn, wheat or potato. Thus the complete make-up of corrugated board is from natural, sustainable materials in plentiful supply. Cardboard is fully recyclable and can be pulped down to make more paper for more board once it has ended its useful life. Cardboard is a highly ecologically friendly material. This is of great concern to construction companies and builders these days, as the disposal of any construction site waste incurs dumping fees in landfills and these costs can become very high, cutting down on their overall profits. Recycling alleviates these environmental protection issues.

Among other materials, various types of cardboard may be used for the purpose of this invention. Cardboard may include, but is not limited to, corrugated cardboard, non-corrugated cardboard, single-liner cardboard, double-liner cardboard, double fluting medium cardboard, triple fluting medium cardboard, double “sandwiched” cardboard, triple “sandwiched” cardboard, celled medium cardboard and honeycombed medium cardboard among others. Combinations of these cardboard is also within the scope of this invention. For the embodiments of this invention, the first and second door surface covers 12 and 14 are preferably made of a double-liner cardboard with single fluting medium cardboard or with honeycombed medium cardboard. Preferably, the honeycombed cardboard medium may have an individual cell size of between about ⅛ to about one inch. The double-liner with honeycombed medium cardboard is disclosed in co-owned U.S. Pat. No. 6,996,860 titled “Construction Protective Covering” issued on Feb. 14, 2006, which is incorporated herein in its entirety.

For all the embodiments of the present invention, the selected materials are especially adapted for the purpose that they can be easily re-shaped or custom cut on site. For example, when double liner cardboard is used, a simple utility knife may be used to customize the door wrap. This turns out to be an important feature in many circumstances when the door wrap is being used on non-standard sized doors, such as furnace doors, laundry doors, closet doors, and the like. Therefore, the ability to be easily customized as the door wrap provides flexibility heretofore is unknown.

Cardboard materials generally provide a non-scratching surface. Consequently, a door wrap made of cardboard would not damage or harm the surface of the door. Furthermore, if a door needs extra protection for its delicate, fragile or decorated surfaces, the first and second door surface covers may be made of corrugated cardboard with a soft, protective sheeted exterior skin, which will provide extra protection for the door. The protective sheeted exterior skin may be made of any suitable material such as paper, plastic or foam.

The middle joining section 16 attaches to one end of each of the first door surface cover 12 and the second door surface cover 14 to fasten or connect the top portions of first door surface cover 12 and second door surface cover 14 together. Middle joining section 16 is preferably flexible and relatively thin sheet material that allows the door wrap 10 to engage with the top edge portion 22 of the door 18 for the purpose of suspending the door wrap 10 over the door 18 and positioning the door wrap 10 laterally relative to the door 18. Preferably, the middle joining section covers the top of the door wrap, when installed, and may extend downwardly from about one eighth (⅛) to one-tenth ( 1/10) of the overall length of the door to be covered. The middle joining section 16 of the door wrap 10 provides additional protection to the top edge portion of the door, while still allowing the door to be used, as if uncovered.

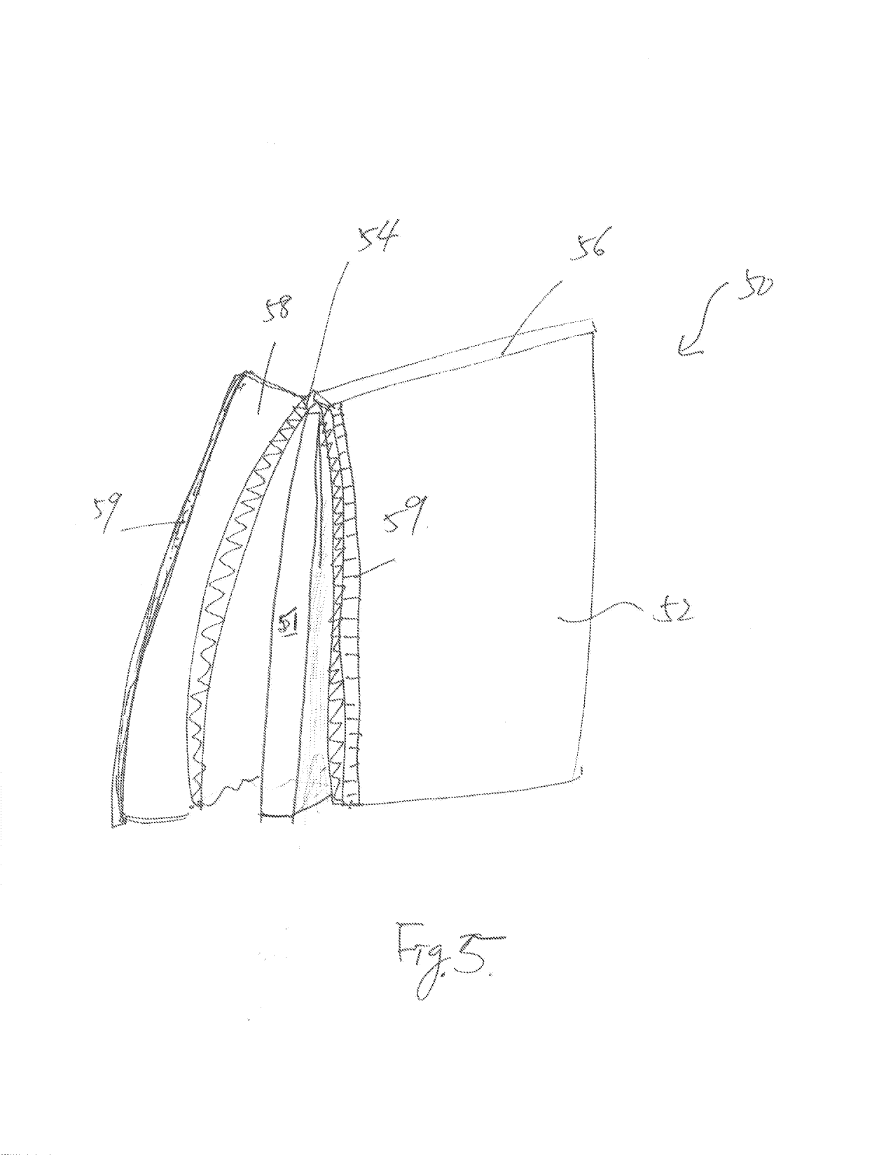

Middle joining section 16 may be made of any suitable material such as paper, cardboard, plastic and wood. Preferably, middle joining section 16 may be made of non-woven polypropylene sheet having a thickness of from about 3 to 5 mil. The door wrap 10 may optionally further have a side-edge cover (see FIG. 5) attached along one side of the surface covers to further protect one side-edge of the door opposite to the side edge hinge. The side-edge cover may be made of the same material as the middle joining section 16. Optionally, any conventionally available securing member may be used to embrace the door wrap around three or all sides of the door. Such a securing member may include adhesive stripes, Velcro strips, tapes, rubber bands or any combination thereof made of any suitable material.

The door wrap 10 may also be formed of a single piece of any suitable material such as cardboard, paper, wood or plastic. Of these materials, the flexible ones, i.e. plastic, paper and certain single-skinned cardboards may be draped over the door. In this embodiment, the inventors also envision that the door wrap may also be secured by adhesives on an edge or on both edges.

It is also contemplated by the present inventors that the materials used for the door wrap may be water resistant, fire resistant, oil resistant and/or recyclable, depending upon the applications. For the water resistant protective covering, a water impermeable spray coating is preferably sprayed onto the contacting surface on the door wrap, although a separate plastic sheet may be adhered onto the door wrap to affect water resistance. The same arrangement is possible for the other material attributes desired, such as fire resistance, or oil resistance, where a coating or an additional sheet of fire or oil resistant material may be contacted on the surface of the door wrap. Fire and oil resistance properties may be achieved by the use of heat reflecting polymers or lipidphilic polymers coated onto the door wrap.

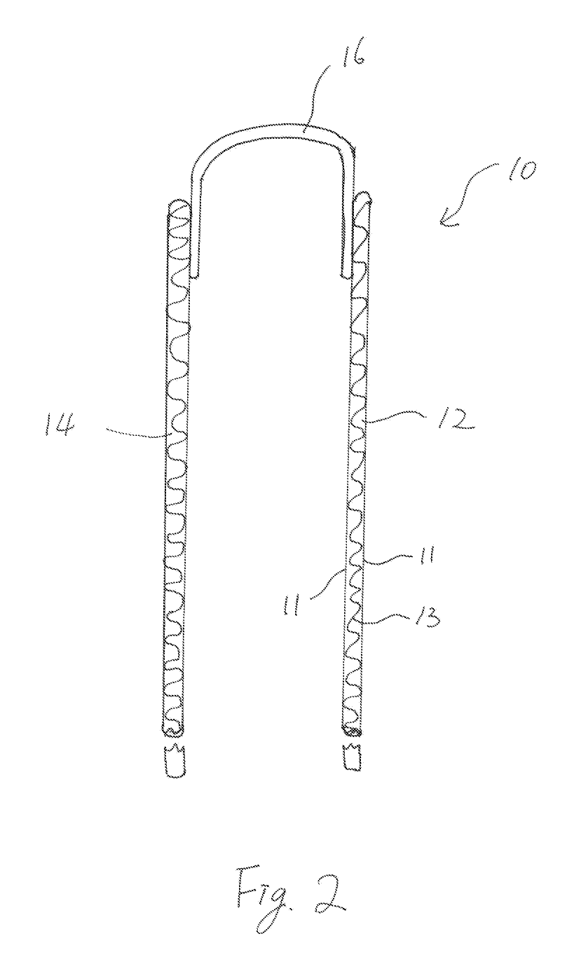

FIG. 2 is a side cross-sectional view of the door wrap of the first embodiment illustrated in FIG. 1. Again, door wrap 10 includes first door surface cover 12, second door surface cover 14 and a middle joining section 16. Each of the first and second door surface covers 12 and 14 preferably is in a substantially rectangular shape that may be dimensioned for covering substantially the entire door (not shown). Preferably, the surface covers 12 and 14 are made of double liners 11 sandwiching a filling medium 13. As described above, the filling medium may is preferably be a single fluting medium cardboard or a honeycombed medium. Different filling media of the cardboard may be selected, without undue experimentation to determine the strength of press resistance that gives cushioning protection to covered doors.

Middle joining section 16 attaches to one end of first door surface cover 12 and second door surface cover 14 to fasten or connect the top portions of first door surface cover 12 and second door surface cover 14 together. Middle joining section 16 is generally flexible and soft. While it is in use, middle joining section 16 may be U shaped to allow door wrap 10 to engage with the top edge portion of the door. More particularly, the middle joining section 16 suspends the door wrap 10 on the door and positions the door wrap 10 laterally relative to the door. The door wrap is preferably lightweight and may be lifted by a person to install on the door.

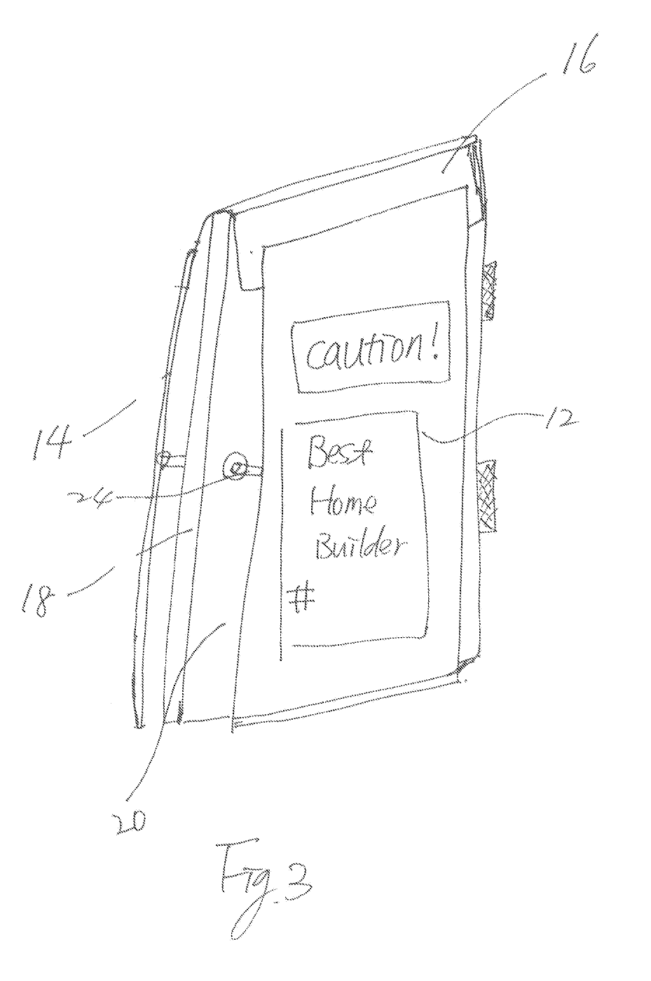

FIG. 3 is a side perspective view of a protective door showing the door wrap over a doorknob 24, and illustrating the relative placement of a preferred embodiment of the door wrap of FIG. 1. First door surface cover 12 and second door surface cover 14 of the door wrap 10 may or may not cover the doorknob 24 depending on the width of door wrap 10, while reducing damage, harm or contact to the door. Here, the first door surface cover 12 and second door surface cover 14 may fully cover the doorknob 24, if applying to an interior door. When the door surface covers cover the doorknob 24, the door may still be operated normally, such as being open, close or locked. The door wrap of the present invention applies to both the brand new doors without doorknobs installed yet (shown in FIG. 1.), or it may be used on doors with doorknobs installed.

In addition to protecting the door, the first door surface cover 12 and second door surface cover 14 of the door wrap 10 may be utilized as marketing tools, as they may be effective billboards for a printed name of the builder, i.e. Best Home Builder, while the door wrap is used at the construction site. This billboard effect may also help to give a place for warnings for the construction workers, such as “Stop: Do-Not-Enter,” or “Caution.”

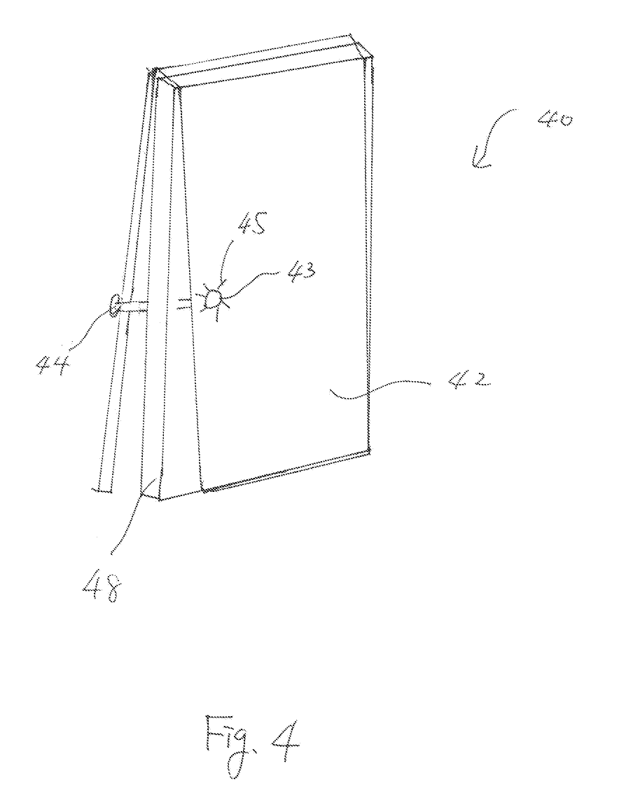

FIG. 4 is a perspective view of a second embodiment of a door wrap generally indicated by the numeral 40 made in accordance with the present invention. The door wrap 40 may be a single piece and may have a substantially rectangular shape that is dimensioned to cover various sizes of doors. The door wrap 40 may be made of any suitable material, as described above for the first embodiment. The door wrap 40 positions and covers a door 48 that has a doorknob 44 installed by an edge thereof. Door wrap 40 may have a round area of perforations 43 above the doorknob 44 to provide knock-out portions to accommodate a door knob. Optionally, each round perforation 43 may include radial slots 45 directed outwardly from perforations 43. Slots 45 provide extra accommodation for an irregular doorknob therethrough. The door wrap of the present invention may be used reversibly; therefore, the knock-out portions located at both the right and left edges are not required. The door wrap 40 applies to both right and left opening doors.

FIG. 5 is a perspective view of a third embodiment of a door wrap generally indicated by the numeral 50 made in accordance with the present invention. Door wrap 50 may be a single piece including a first door surface cover 52, a second door surface cover 54, a middle joining section 56 and a side-edge cover 58 extending along the length of one of the surface covers 52 and 54. Door wrap 50 is preferably sized and shaped to cover an entire door 51. The first door surface cover 52 and the second door surface cover 54 are connected to each other through the middle joining section 56. The side-edge cover 58 may be attached along one end of the first door surface cover 52, the second door surface cover 54, or the middle joining section 56.

Optionally, a securing member 59 may be used to fasten the side-edge cover 58 to the other surface cover or both surfaces covers. With the side-edge cover 58, the door wrap 50 is able to embrace around three sides of the door. The securing member may be adhesives, Velcro® strips, tapes, rubber bands or any suitable material. Here, the securing member 59 is a pair of Velcro strips including loops and hooks. One of the pair of Velcro strips is attached along the edge of the side-edge cover 58; the other is fastened along first door surface cover 52. After pressing the side-edge cover 58 over first door surface cover 52, the door is covered substantially.

Door wrap 50 may be made of any suitable material, as described above for the first embodiment. Door wrap 50 is preferably made of a single-liner cardboard or single skin sheeted plastic and may be custom cut at the construction side by ordinary tools such as knife, blades, scissors, and shears. Optionally, the door wrap may have a soft, protective sheeted exterior skin, so that the door wrap would not harm the surface of any delicate, fragile, crafted or decorated doors. The protective sheeted exterior skin may be made of any suitable material such as paper, plastic or foam.

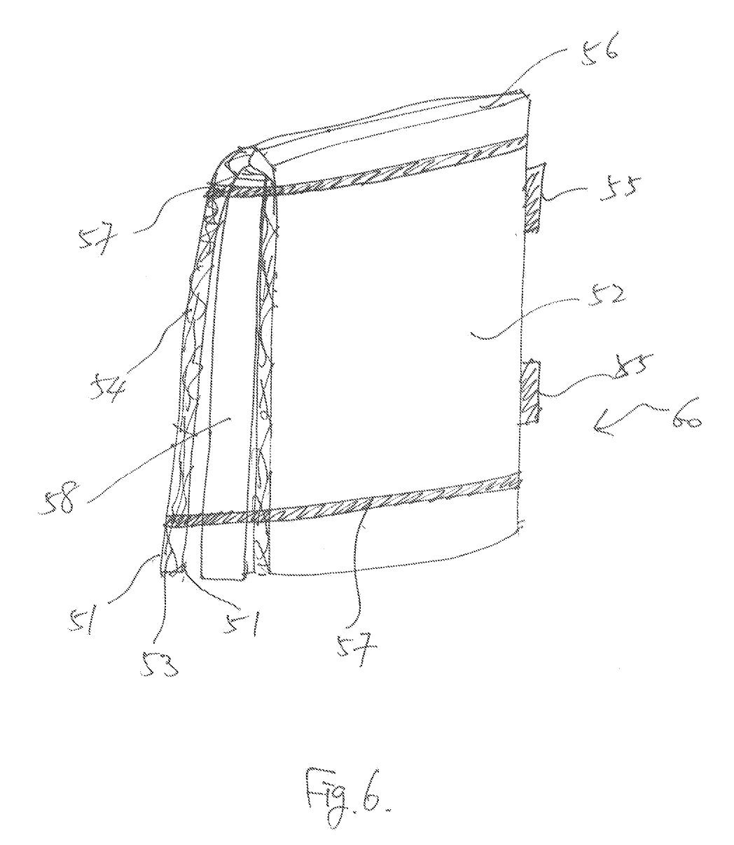

FIG. 6 is a perspective view of a fourth embodiment of a door wrap generally indicated by the numeral 60 made in accordance with the present invention. The door wrap 60 may have a first door surface cover 62, a second door surface cover 64, a middle joining section 56 and a side-surface cover 68. The first door surface cover 62 and the second door surface cover 64 are connected to each other through the middle joining section 66. The side-surface cover 68 may be connected to one end of the first door surface cover 62, the second door surface cover 64, or the middle joining section 66. The door wrap, including first door surface cover 62, the second door surface cover 64, and the middle joining section 56 and the side-surface cover, may be a single piece and made of any suitable material as described above for the first embodiment. Preferably, the single piece may be made of cardboard, foam or bubble plastic sheet. The door wrap 60 may further have a securing member 57 to embrace the door wrap around the door. The securing member may be an adhesive, Velcro® strips, tapes, rubber bands or any suitable material. Preferably, a pair of rubber bands may be used as a securing member as shown in FIG. 6.

In summary, numerous benefits have been described which result from employing any or all of the concepts and the features of the various specific embodiments of the present invention, or those that are within the scope of the invention. The door wrap of the present invention provides an improved and novel door wrap that allows doors of various sizes to be easily and quickly covered, by the first and second door surface covers being hung on and wrapped around the door, by a single person, to protect substantially all, if not all, of the surfaces of such a door, against damage. Furthermore, the size of the first and second door surface covers of the door wrap may be specifically configured so as to work on any door. The first and second door surface covers may be custom made to fit a specific door, or made in large quantities to fit standard size doors. The middle joining section of the door wrap provides additional protection to the top edge portion of the door, while allowing the door to be continued to used, as if uncovered. Furthermore, because of its durability and ease in use, the door wrap of this invention may be used over and over again, saving time, money, materials and energy.

The foregoing description of a preferred embodiment of the invention has been presented for purposes of illustration and description. It is not intended to be exhaustive or to limit the invention to the precise form disclosed. Obvious modifications or variations are possible in light of the above teachings with regards to the specific embodiments. The embodiment was chosen and described in order to best illustrate the principles of the invention and its practical applications to thereby enable one of ordinary skill in the art to best utilize the invention in various embodiments and with various modifications as are suited to the particular use contemplated.

What is claimed is:

1. A door wrap adapted to cover a door, having a front surface, a back surface, side edges and a top edge, hung in a frame to prevent damage, the door wrap comprising:
a first and second surface covers having a substantially rectangular shaped portion dimensioned for covering substantially all of the front or back surface of the door;
a connector connecting the first and second surface covers together to be adapted to cover and protect the door, wherein the member adapted to cover a fraction of the top edge or side edges.

2. The door wrap of claim 1, wherein the first and second surface covers are made of material selected from the group consisting of cardboard, plastic, wood, paper and combinations thereof.

3. The door wrap of claim 1, wherein the first and second surface covers are constructed in a honeycomb cardboard configuration.

4. The door wrap of claim 1, wherein the connector attaches to one end of the first and second surface covers to be adapted to engage with the top edge of the door for suspending the door wrap over the door while positioning the door wrap laterally relative to the door.

5. The door wrap of claim 4, wherein the connector is made of non-woven polypropylene.

6. The door wrap of claim 1, wherein the connector is at least a rubber band adapted to hold the first and second sections together around the front surface and the back surface of the door.

7. The door wrap of claim 1, wherein the connector is selected from the group consisting of adhesive, stripes, Velcro® strips, tapes, rubber bands and combinations thereof.

8. A door wrap adapted to cover a door, having a front surface, a back surface and a top edge, hung in a frame to prevent damage, the door wrap comprising:
a first and second surface covers adapted to be secured together over and around the door for covering substantially both the front and back surface of the door; and
a middle joining section attached to one end of the first and second surface covers to connect the first and second surface covers and adapted to engage with the top edge portion of the door for suspending the door wrap over the door while positioning the door wrap laterally relative to the door.

9. The door wrap of claim 8, wherein the first and second surface covers are made of material selected from the group consisting of cardboard, plastic, wood, paper and combinations thereof.

10. The door wrap of claim 8, wherein the first and second surface covers are constructed in a cardboard honeycomb configuration having an individual cell size of between about ⅛″ to about 1″.

11. The door wrap of claim 8, wherein the middle joining section is made of material selected from the group consisting of, cardboard, rubber, plastic, wood, and paper and combinations thereof.

12. The door wrap of claim 8, wherein the middle joining section is a sheet of non-woven polypropylene that has a thickness of from about 3 to 5 mil.

13. The door wrap of claim 8 further comprising a side-surface cover attached to one end of the first door surface cover, the second door surface cover, or the middle joining section.

14. The door wrap of claim 8 further comprising a securing member fastening the first and second sections together to be adapted to cover and protect the door, wherein the securing member adapted to cover a fraction of the top edge or side edges.

15. The door wrap of claim 8, wherein the securing member is selected from the group consisting of adhesive, stripes, Velcro® strips, tapes, rubber bands and combinations thereof.

16. A door wrap adapted to cover a door, having a front surface, a back surface and a top edge, hung in a frame to prevent damage caused, the door wrap comprising:
a first and second cardboard sections adapted to be secured together over and around the door for covering substantially both the front and back surface of the door; and
a plastic joining section attached to one end of the first and second cardboard sections to connect the first and second cardboard sections and adapted to engage with the top edge portion of the door for the purpose of suspending the door wrap over the door while positioning it laterally relative to the door.

17. The door wrap of claim 16, wherein the first and second cardboard sections are constructed in a cardboard honeycomb configuration having an individual cell size of between about ⅛″ to about 1″.

18. The door wrap of claim 16, wherein the plastic joining section is a sheet of non-woven polypropylene that has a thickness of from about 3 to 5 mil.
